(19) United States
(12) Patent Application Publication
(10) Pub. No.: US 2006/0088369 A1
(43) Pub. Date: Apr. 27, 2006

(54) Extendible rod locking sleeve structure

(76) Inventor: Ping-Ling Wang, Changhua (TW)

Correspondence Address: TROXELL LAW OFFICE PLLC, SUITE 1404, 5205 LEESBURG PIKE, FALLS CHURCH, VA, 22041, US

(21) Appl. No.: 10/969,958

(22) Filed: Oct. 22, 2004

(51) Int. Cl. F16B 7/10

(52) U.S. Cl. 403/109.1

(57) ABSTRACT

An extendible rod locking sleeve structure consisting of a U-shaped seating sleeve having a small and a large facing annular opening and, furthermore, a bolt or an eccentric lever perpendicularly disposed at the back side of the center section capable of reversible forward engagement by thread fastening or an articulated thrusting motion such that both the inner rod and the outer rod comprising an extendible rod inserted through the two annular openings become fully locked down at the upper and lower positions of the ensleeved area. Among the features of the present invention, the seating sleeve upper and lower annular openings have inwardly protruding curved insertional stop plates formed along the superficial lateral portions of one or both of their interior edges that are utilized for nesting into the intervallicly arrayed annular grooves in the walls of one or both the inner rod and the outer rod, enabling the insertional stop plates enslotted into the annular grooves to effectively achieve stable lock down capability.

### BACKGROUND OF THE INVENTION

1) Field of the Invention

The invention herein relates to an extendible rod locking sleeve structure consisting of a U-shaped seating sleeve having a small and a large facing annular opening and, furthermore, a bolt or an eccentric lever perpendicularly disposed at the back side of the center section capable of reversible forward engagement by thread fastening or an articulated thrusting motion such that both the inner rod and the outer rod comprising an extendible rod inserted through the said two annular openings become fully locked down at the upper and lower positions of the ensleeved area, the features of which are: The seating sleeve upper and lower annular openings have inwardly protruding curved insertional stop plates formed along the superficial lateral portions of one or both of their interior edges that are utilized to for nesting into the intervallicly arrayed annular grooves in the walls of one or both the inner rod and the outer rod, enabling the said insertional stop plates enslotted into the annular grooves to effectively achieve stable lock down capability.

2) Description of the Prior Art

With conventional dual-segment or multi-segment extendible rods, the fixing operation after the inner rod is extended to a certain height includes the commonly observed screw-fastened sleeve tightening methods at the inner rod top extremity of cleaning appliances as well as movable inner and outer rods that necessarily have a member or other structure exhibiting an optimized degree of lock down tightness, but in most, this is typically accomplished by means of a bolt that is fastened inward at the top section of the outer rod and driven tightly against the walls of the inner rod such that upward and downward sliding is not possible; as such, since such structures damage the surface of the inner rod, the shortcomings include uneven locking effectiveness and, furthermore, poor tightening characteristics.

As such, existent structures (referring to FIG. 1 and FIG. 2) respectively consist of a U-shaped seating sleeve 2 having a small and a large facing annular opening 21 and 22 and, furthermore, a bolt 23 (as shown in FIG. 1) or an eccentric lever 44 (as shown in FIG. 2) perpendicularly disposed at the back side of the center section capable of reversible forward engagement by thread fastening or an articulated thrusting motion such that both the inner rod 31 and the outer rod 32 comprising an extendible rod 3 inserted through the said two annular openings 21 and 22 become stably ensconced at the upper and lower positions of the ensleeved area, which thereby completes the lock down operation.

However, in the structure of the said U-shaped seating sleeve 2, the arrangement of the annular openings 21 and 22 is for utilization on the smooth walled inner rod 31 and outer rod 32 of the extendible rod 3, with the pressure of forced linear contact constituting the lock down state; as such, operation at the inner rod 31 and outer rod 32 surfaces produces pressure mutilations that are unavoidable; furthermore, since the inner rod 31 and the outer rod 32 surfaces have a smooth finish, when subjected to powerful, destructive external force, the annular openings 21 and 22 become totally immovable or obstructed from sliding upward and downward because they no longer fit properly and with consequent back shifting that cannot be prevented, and the inner rod 31 and the outer rod 32 surfaces become scratched, adversely affecting both functional utility and aesthetic attractiveness.

In view of the said structural shortcomings, the invention herein introduces an extendible rod having intervallicly arrayed annular grooves disposed along the conjoinment-use surfaces.

### SUMMARY OF THE INVENTION

The primary objective of the invention herein is to provide an extendible rod locking sleeve structure consisting of a U-shaped seating sleeve having a small and a large facing annular opening and, furthermore, a bolt or an eccentric lever perpendicularly disposed at the back side of the center section capable of reversible forward engagement by thread fastening or an articulated thrusting motion that are utilized for the conjoinment of an extendible rod having intervallicly arrayed annular grooves along its walls; the seating sleeve upper and lower annular openings have inwardly protruding curved insertional stop plates formed along the superficial lateral portions of their interior edges such that the said insertional stop plates are nested stationary in the annular grooves along the wall surfaces of the extendible rod; as such, after the U-shaped seating sleeve is completely locked down, since the insertional stop plates are immovably enslotted in the recessed annular grooves, the probability of upward and downward dislodging or shifting by the U-shaped seating sleeve is obviously improved because of its stable lock down effectiveness, which is among the features of the present invention.

Another objective of the invention herein is to provide an extendible rod locking sleeve structure, wherein since the conjoinment-use surfaces are intervallicly arrayed annular grooves along the walls of the extendible rod, a general predetermined or user setting of the extendible rod to a certain height provides for utilization according to the height position defined by the annular grooves, which definitely facilitates efficient rapid adjustment to a predetermined height and further optimizes operating convenience, which is also among the features of the present invention.

### BRIEF DESCRIPTION OF THE DRAWINGS

FIG. 1 is an exploded drawing of the first prior art structure.

FIG. 2 is an exploded drawing of the second prior art structure.

FIG. 3 is an exploded drawing of the first embodiment of the invention herein.

FIG. 4 is an exploded drawing of the second embodiment of the invention herein.

FIG. 5 is a cross-sectional drawing of the first embodiment of the invention herein.

FIG. 6 is a cross-sectional drawing of the second embodiment of the invention herein.

FIG. 7 is a cross-sectional drawing of the third embodiment of the invention herein.

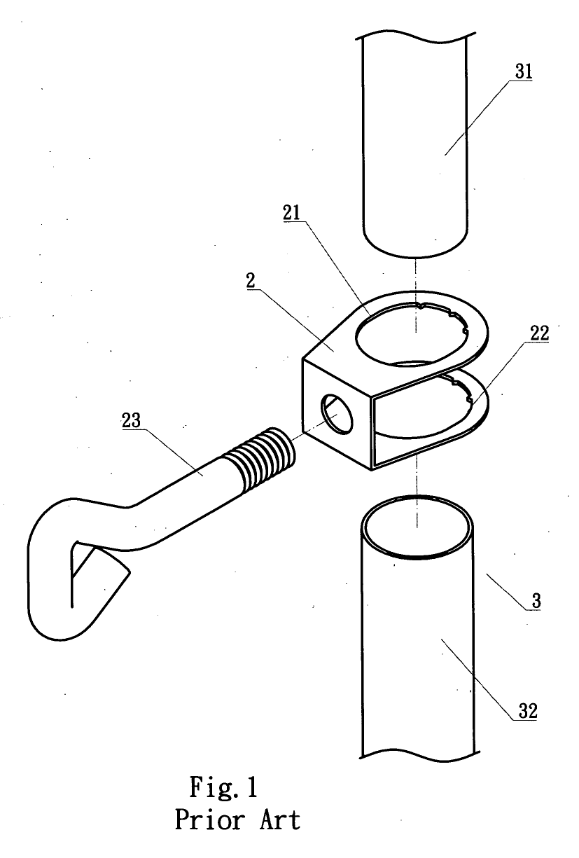

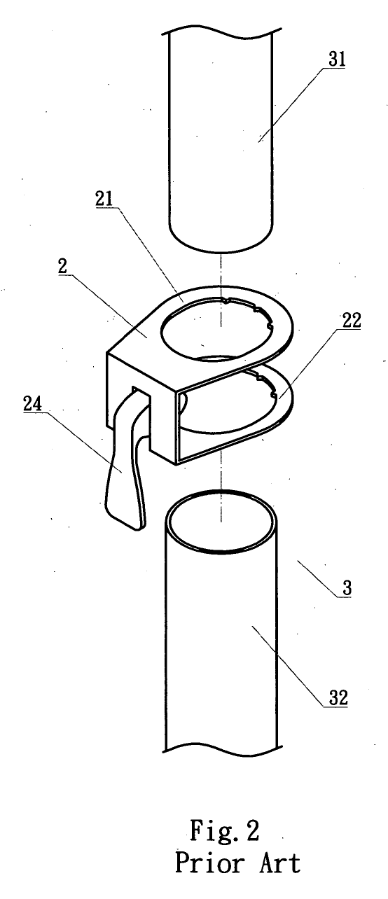

### DETAILED DESCRIPTION OF THE PREFERRED EMBODIMENTS

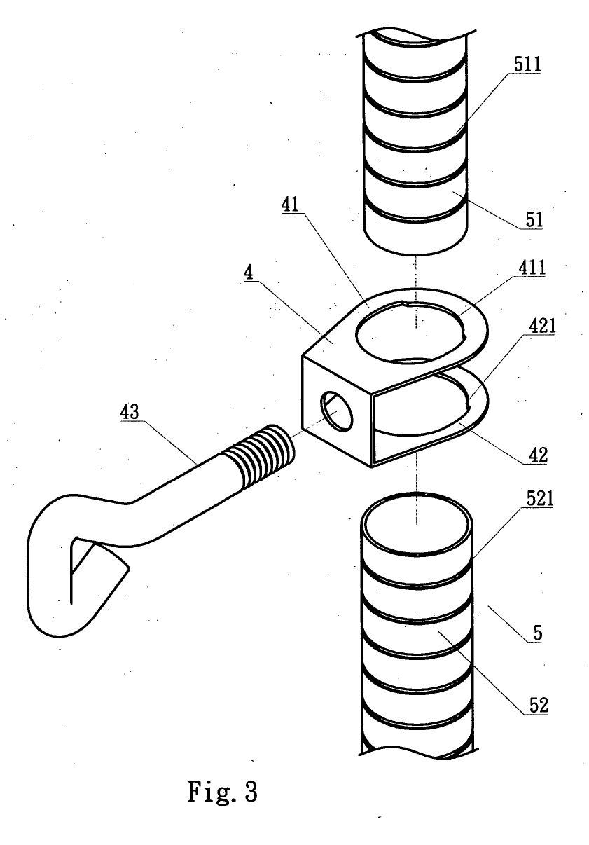

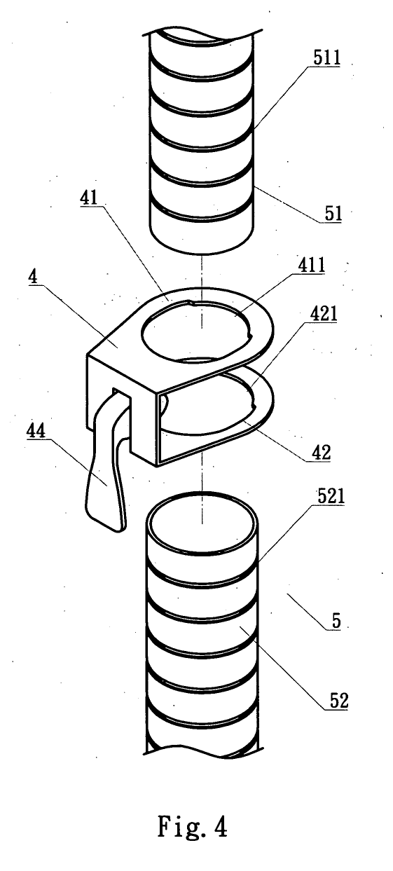

Referring to FIG. 3 and FIG. 4, the structural features and operating particulars of the invention herein, the present invention consists of a U-shaped seating sleeve 4 having a small and a large facing annular opening 41 and 42 and, furthermore, a bolt 43 (as shown in FIG. 3) or an eccentric lever 44 (as shown in FIG. 4) perpendicularly disposed at the back side of the center section capable of reversible forward engagement by thread fastening or an articulated thrusting motion such that both the inner rod 51 and the outer rod 52 comprising an extendible rod 5 inserted through the said two annular openings 41 and 42 become fully locked down at the upper and lower positions of the ensleeved area, wherein the features of the invention herein are:

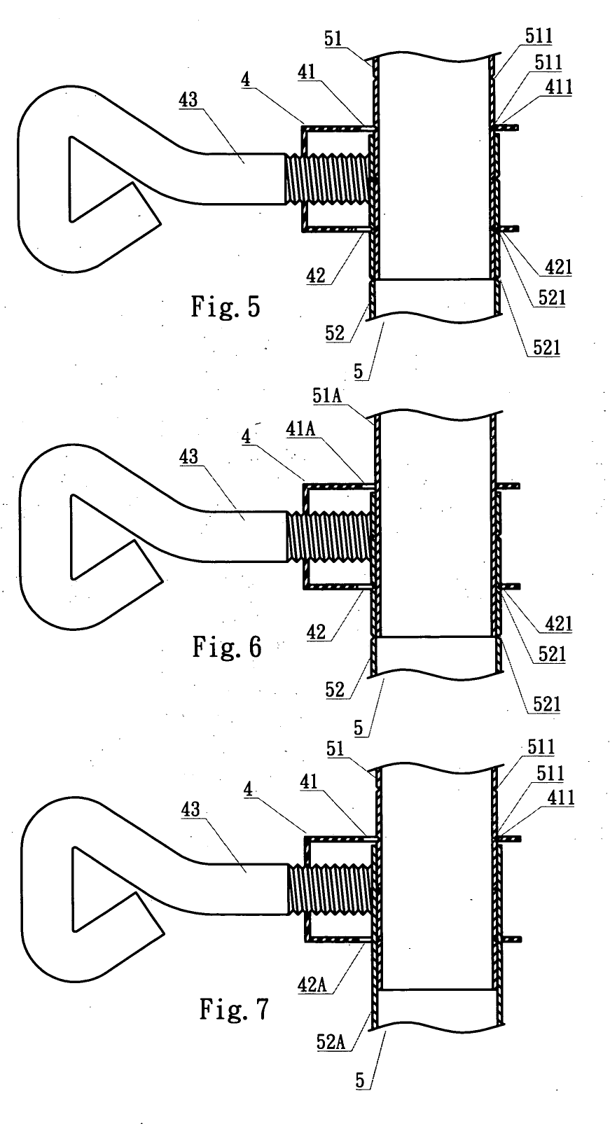

The seating sleeve 4 upper and lower annular openings 41 and 42 have inwardly protruding curved insertional stop plates 411 and 421 formed along the superficial lateral portions of their interior edges that are utilized to for nesting into intervallicly arrayed annular grooves 511 and 521 in the walls of the inner rod 51 and the outer rod 52; after the intervallicly arrayed annular grooves 511 and 521 on the extendible rod 5 inner and outer rods 51 and 52 are respectively aligned with the selected insertional stop plates 411 and 421 at the ensleeved area, the U-shaped seating sleeve 4 is engaged forward by means of the bolt 43 (or the eccentric lever 44), forcing the upper and lower annular openings 41 and 42 to recede towards the back such that the said insertional stop plates 411 and 421 are gradually guided into the annular grooves 511 and 521 until finally locked down to a fixed position, at which time since the insertional stop plates 411 and 421 are enslotted in the recessed annular grooves 511 and 521 such that the insertional stop plates 411 and 421 cannot be dislodged or shifted upward or downward, but are stably clasped at the set adjusted length of the extendible rod 5 (as shown in FIG. 5).

Since the upper and lower annular openings 41 in the seating sleeve 4 are of a one-piece arrangement, only a single upper opening 41 with a curved insertional stop plate 411 is needed to fit onto the inner rod 51 having the annular grooves 511 on its intervallically contoured rod body, a lower opening 42A originally fabricated without the insertional stop plate then fitting onto a smooth walled outer rod 52A (as shown in FIG. 6); or only the remaining lower opening 42 is with a curved insertional stop plate 421 fits onto the outer rod 52 having the annular grooves 521 on its intervallically contoured rod body, the upper opening 41A originally fabricated without the insertional stop plate then fitting onto a smooth walled inner rod 51A (as shown in FIG. 7) and, as such, saving a portion of the machining cost for the extendible rod 5 annular grooves, but achieving identical lock down and fixing capability.

1. An extendible rod locking sleeve structure consisting of a U-shaped seating sleeve having a small and a large facing annular opening and, furthermore, a bolt or an eccentric lever perpendicularly disposed at the back side of the center section capable of reversible forward engagement by thread fastening or an articulated thrusting motion such that both the inner rod and the outer rod comprising an extendible rod inserted through the two said annular openings become fully locked down at the upper and lower positions of the ensleeved area, the features of which are: The said seating sleeve upper and lower annular openings have inwardly protruding curved insertional stop plates formed along the superficial lateral portions of one or both of their interior edges that are utilized for nesting into the intervallicly arrayed annular grooves in the walls of one or both the said inner rod and the said outer rod, enabling the said insertional stop plates enslotted into the said annular grooves to effectively achieve stable lock down capability.
